(19) United States
(12) Patent Application Publication
(10) Pub. No.: US 2005/0198145 A1
(43) Pub. Date: Sep. 8, 2005

(54) Pay e-mail methods and systems

(75) Inventor: Gary M. Davis, Rochester, NY (US)

Correspondence Address: ORTIZ & LOPEZ, PLLC;Patent Attorneys, P.O. Box 4484, Albuquerque, NM, 87196-4484, US

(73) Assignee: Xerox Corporation

(21) Appl. No.: 10/756,148

(22) Filed: Jan. 12, 2004

(51) Int. Cl. G06F 15/16

(52) U.S. Cl. 709/206

(57) ABSTRACT

A database can be compiled, which includes a list of pre-approved e-mail addresses from which e-mail messages thereof are approved for transmission to a particular e-mail recipient. Thereafter, a particular e-mail address is automatically compared to the database of pre-approved e-mail addresses, in response to transmitting an e-mail message from the particular e-mail address to the particular e-mail recipient. Next, an automatic offering can be provided by a clearinghouse to approve the particular e-mail address for transmission of the e-mail message and subsequent e-mail messages from the particular e-mail address to the particular e-mail recipient in return for a payment thereof if the particular e-mail address does not match a pre-approved e-mail address in the database of pre-approved e-mail addresses.

### TECHNICAL FIELD

Embodiments are generally related to data-processing methods and systems. Embodiments are also related to communications filtering methods and systems. Embodiments are also related to methods and systems for filtering and managing unsolicited electronic mail.

### BACKGROUND OF THE INVENTION

Electronic mail (“e-mail”) relates to the exchange of text messages and computer files over a communications network such as the well-known Internet and/or wireless communications network. E-mail users possess e-mail addresses to which e-mail can be sent and received over such communications networks. An e-mail address is essentially a string that identifies a user to that the user can receive e-mail. An e-mail address typically includes a name that identifies the user to a mail server, followed by a “@” symbol and a host name and domain name of the server.

The problem of unsolicited e-mail has grown increasingly in recently years, and received considerable attention. Such e-mail is known characteristically as “junk” e-mail. Some background is thought to be helpful in understanding the conventional problems and solutions that have been used and proposed, as well as the basic e-mail process.

Referring to FIG. 1, a conventional process of sending e-mail messages from a source client 110 to a destination client 140 is illustrated. A source client 110 can composes an e-mail message, which is then sent from the source client 110 to a source simple mail transfer protocol (SMTP) server 120. The source SMTP server 120 sends the e-mail message to a destination SMTP server 130, which then sends the e-mail message to the destination client 140. A major drawback in such conventional processes is the ever increasing amount of junk e-mail messages received by the destination clients 140. Such junk e-mail messages include advertisements for numerous goods and services. Users of e-mail systems have been spending an increasing amount of time separating their regular e-mail messages from unwanted e-mail messages.

Attempts have been made to reduce the number of junk e-mail messages received by the destination clients. Some methods require the source client to add descriptive information to the e-mail message so that the destination SMTP server can prevent undesired e-mail messages from being sent to the destination client. These methods are basically ineffective because the senders of junk e-mail messages will not add the descriptive information, which will allow destination clients to block the junk e-mail messages. Additionally, legitimate e-mail senders, unaware of such requirements, are unable to reach the intended recipient.

Another method involves the requirement of a response from the sender to a question related to a human-readable image or other challenge prior to the delivery of the original message. The intent of such a technique is to prevent automated responses by computers sending bulk e-mail which increases the cost of transmitting such bulk e-mail. Such methods not only present barriers to visually impaired users, but technology may eventually be developed that permits an automated response to such challenges.

Filter-out methods have also been developed. With such filter-out methods, a database of known sources (i.e., source clients) of junk e-mail messages is compiled (e.g., a “black-list”). The destination SMTP server compares the source client's e-mail address to the e-mail addresses in the database and does not send undesired e-mail messages to the destination client. These methods have also proven to be ineffective because of the development of robotic delivery programs. These robotic delivery programs send out thousands of junk e-mail messages and create nonexistent source client e-mail addresses. Thus, when one source client e-mail address is blocked, a new address is created. As a consequence, the database of known sources of junk e-mail messages cannot keep up with changing e-mail addresses created by the robotic delivery programs.

Filter-in methods have also been developed. With filter-in methods, a database of known trusted sources of desired e-mail is compiled (e.g., a “white-list”). The destination SMTP server compares the source client's e-mail address to the e-mail addresses in the database and allows delivery only of desired e-mail messages to the destination client. These methods have also proven to be ineffective because of the ability to forge e-mail header information and effectively impersonate a sender. Also, a trusted sender who changes their e-mail address may no longer be able to reach the intended recipient.

Unsolicited or “junk” e-mail has proliferated because a financial barrier does not exist against such mass e-mailings. It generally costs no more to send mail to millions of e-mail accounts than to a single e-mail account. Unsolicited e-mail is responsible for increased network traffic, consumer annoyance, unwanted and offensive content, and if allowed unchecked, can render e-mail less usable. Filters allow users to block specific addresses or filter for keywords, but may allow unwanted e-mail through and may also be responsible for preventing desired e-mail from reaching its destination. The configuration and perfections of such filter-based methods and systems, however, is difficult to install and maintain. To overcome these drawbacks, improved e-mail methods and systems are disclosed herein.

### BRIEF SUMMARY

It is a feature of the present invention to provide improved data-processing methods and systems.

It is also a feature of the present invention to provide improved methods and systems for filtering and managing unsolicited e-mail messages.

It is also a feature of the present invention to provide improved methods and systems for electronically transferring funds.

Aspects of the present invention relate to methods and systems for filtering e-mail messages, including reliable incentives for configuring and maintaining a filtering database and methods for transferring funds electronically. A database of pre-approved e-mail addresses from which e-mail messages thereof are approved for transmission to a particular e-mail recipient can be compiled. Thereafter, a particular e-mail address can be automatically compared to the database of pre-approved e-mail addresses, in response to receiving an e-mail message from the particular e-mail address to the particular e-mail recipient. Next, an automatic offering can be provided by a clearinghouse to approve the particular e-mail address for transmission of the e-mail message and subsequent e-mail messages from the particular e-mail address to the particular e-mail recipient in return for a payment thereof if the particular e-mail address does not match a pre-approved e-mail address in the database of pre-approved e-mail addresses.

The clearinghouse can automatically allow pass-through of the e-mail message to the particular e-mail recipient if the particular e-mail address matches a pre-approved e-mail address in the database of pre-approved e-mail addresses. The clearinghouse can also automatically debit an account associated with a sender of the particular e-mail address, in response to an acceptance by the sender of an offer to pay the particular e-mail recipient for transmission of the e-mail message and subsequent e-mail messages from the particular sender's e-mail address to the particular e-mail recipient in return for the payment thereof. Optionally, the clearinghouse can automatically offer to transmit the name of the sender of the particular e-mail address and the subject of the e-mail message to the particular e-mail recipient if the particular e-mail address does not match a pre-approved e-mail address in the database of pre-approved e-mail addresses. Alternatively, the clearinghouse can retain the message for a predetermined amount of time so that the recipient may review the list of blocked e-mail to be assured that the clearinghouse is not blocking desired messages. Alternatively, the clearinghouse can offer the recipient the ability to refund a sender's payment and/or to grant the sender free access to the recipient's address if the recipient chooses to do so upon receipt of a paid message.

If a sender associated with a customer of the clearinghouse changes their address, the sender would already have recognition of their old address at the clearinghouse website. The clearinghouse could offer a form to enter an old e-mail address and the new address. The change would not be official until the clearinghouse received a reply to a message from the clearinghouse or the clearinghouse received a returned-undeliverable reply. Upon verification by either method, that sender's address would be updated for all recipients that have a relationship with the clearinghouse.

The clearinghouse may optionally request validation from a paying sender for subsequent transmissions for verification of payment associated with a particular message. Such a configuration prevents fraud by unscrupulous senders who may forge e-mail header information to impersonate a paying sender and access the true sender's accounts and funds. The resulting verification may be in the form of a request via return e-mail for a reply from the sending e-mail address (i.e., verifying that the original message came from the apparent sender). The resulting verification can also be implemented utilizing an Internet “link” to a specific web secure page for completion of a password challenge. Verification may also include requiring the sender to use a digital signature in the original e-mail to avoid uncertainty with respect to the origin of the e-mail message.

### BRIEF DESCRIPTION OF THE DRAWINGS

The particular values and configurations discussed in these non-limiting examples can be varied and are cited merely to illustrate one or more embodiments and are not intended to limit the scope thereof.

FIG. 1 illustrates a block diagram of a conventional e-mail system;

FIG. 2 illustrates a block diagram illustrative of a client/server architecture system in which embodiments can be implemented;

FIG. 3 illustrates a detailed block diagram of a client/server architectural system in which an embodiment can be implemented;

FIG. 4 illustrates a high-level network diagram illustrative of a computer network, in which embodiments can be implemented;

FIG. 5 illustrates a high-level flow chart of operations of logical operational steps that can be implemented in accordance with embodiments thereof;

FIG. 6 illustrates a block diagram depicting a system which can be implemented in accordance with an alternative embodiment of the present invention;

FIG. 7 illustrates a block diagram depicting a system which can be implemented in accordance with an alternative embodiment of the present invention;

FIG. 8 illustrates a high-level flow chart of operations of logical operational steps that can be implemented in accordance with alternative embodiments thereof;

FIG. 9 illustrates a high-level flow chart of operations of logical operational steps that can be implemented in accordance with embodiments thereof; and

FIG. 10 illustrates a high-level flow chart of operations of logical operational steps that can be implemented in accordance with embodiments thereof.

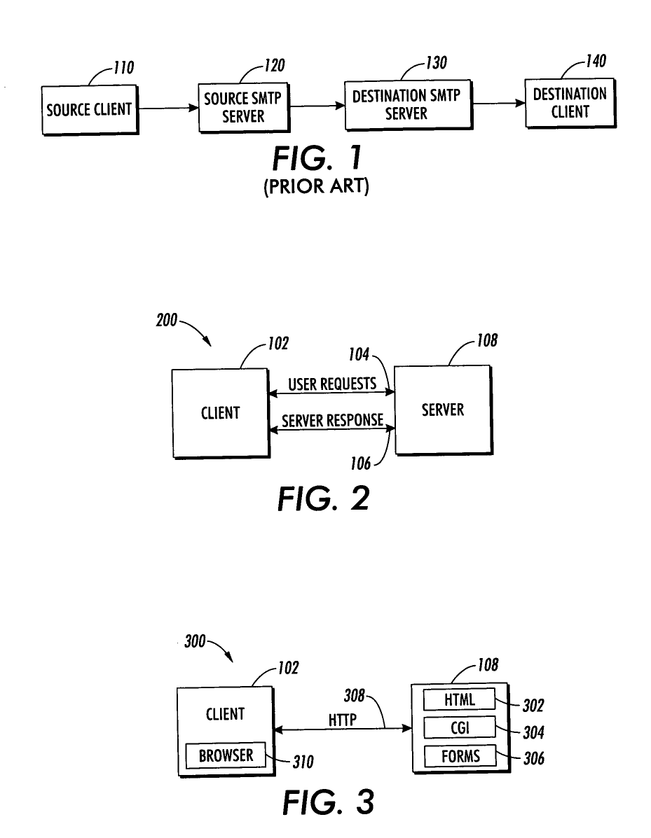

### DETAILED DESCRIPTION OF THE INVENTION

The particular values and configurations discussed in these non-limiting examples can be varied and are cited merely to illustrate embodiments and are not intended to limit the scope of the invention.

FIG. 2 illustrates a block diagram illustrative of a client/server architecture system 200 in which embodiments can be implemented. It can be appreciated by those skilled in the art that the system illustrated with respect to FIGS. 2 to 4 is an example of one type of computer network in which embodiments can be implemented, particularly in the context of e-mail filtering management. Other types of computer networks can also be utilized in accordance with alternative embodiments of the present invention, such as, for example, token ring networks, wireless communications networks, Intranets and/or organizationally dedicated computer networks rather than a more open computer network, such as the Internet. FIGS. 2-4 are thus presented for illustrative purposes only and are not considered limiting features of the present invention.

As indicated in system 200 of FIG. 2, user requests 104 for data can be transmitted by a client 102 (or other sources) to a server 108. Server 108 can be implemented as a remote computer system accessible over the Internet, the meaning of which is known, or other communication networks. Note that the term “Internet” is well known in the art and is described in greater detail herein. Also note that the client/server architecture described in FIGS. 2-4 represents merely an exemplary embodiment. It is believed that the present invention can also be embodied in the context of other types of network architectures, such as, for example company “Intranet” networks, token-ring networks, wireless communication networks, and the like.

Server 108 can perform a variety of processing and information storage operations. Based upon one or more user requests, server 108 can present the electronic information as server responses 106 to the client process. The client process may be active in a first computer system, and the server process may be active in a second computer system, communicating with one another over a communications medium, thus providing distributed functionality and allowing multiple clients to take advantage of information processing and storage capabilities of the server, including information retrieval activities such as retrieving documents from a managed service environment.

FIG. 3 illustrates a detailed block diagram of a client/server architectural system 300 in which an embodiment can be implemented. Although the client and server are processes that are generally operative within two computer systems, such processes can be generated from a high-level programming language, which can be interpreted and executed in a computer system at runtime (e.g., a workstation), and can be implemented in a variety of hardware devices, either programmed or dedicated, such as for example, personal computers, laptop computers, cellular telephone, PDA (Personal Digital Assistant) devices and the like.

Client 102 and server 108 communicate utilizing the functionality provided by HTTP. Active within client 102 can be a first process, browser 310, which establishes connections with server 108, and presents information to the user. Any number of commercially or publicly available browsers can be utilized in various implementations in accordance with the preferred embodiment of the present invention. For example, a browser can provide the functionality specified under HTTP. A customer administrator or other privileged individual or organization can configure authentication policies, as indicated herein, using such a browser.

Server 108 can execute corresponding server software, such as a gateway, which presents information to the client in the form of HTTP responses 308. A gateway is a device or application employed to connect dissimilar networks (i.e., networks utilizing different communications protocols) so that electronic information can be passed or directed from one network to the other. Gateways transfer electronic information, converting such information to a form compatible with the protocols used by the second network for transport and delivery. Embodiments can employ Common Gateway Interface (CGI) 304 for such a purpose.

The HTTP responses 308 generally correspond with “Web” pages represented using HTML, or other data generated by server 108. Server 108 can provide HTML 302. The Common Gateway Interface (CGI) 304 can be provided to allow the client program to direct server 108 to commence execution of a specified program contained within server 108. Through this interface, and HTTP responses 308, server 108 can notify the client of the results of the execution upon completion.

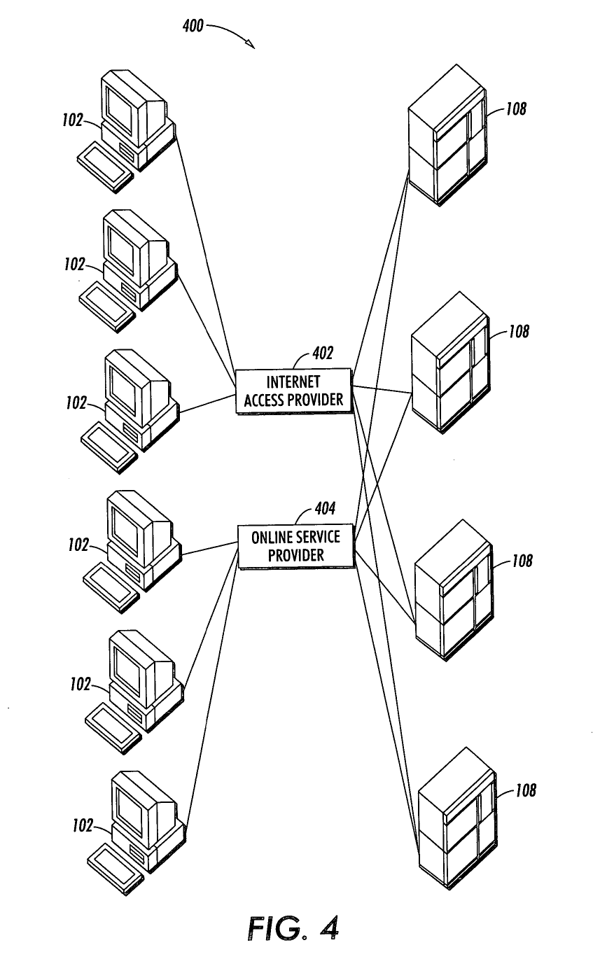

FIG. 4 illustrates a high-level network diagram illustrative of a computer network 400, in which embodiments can be implemented. Computer network 400 can be representative of the Internet, which can be described as a known computer network based on the client-server model discussed herein. Conceptually, the Internet includes a large network of servers 108 that are accessible by clients 102, typically users of personal computers, through some private Internet access provider 402 or an on-line service provider 404.

Each of the clients 102 can operate a browser to access one or more servers 108 via the access providers. Each server 108 operates a so-called “Web site” that supports files in the form of documents and web pages. A network path to servers 108 is generally identified by a Universal Resource Locator (URL) having a known syntax for defining a network collection. Computer network 400 can thus be considered a Web-based computer network.

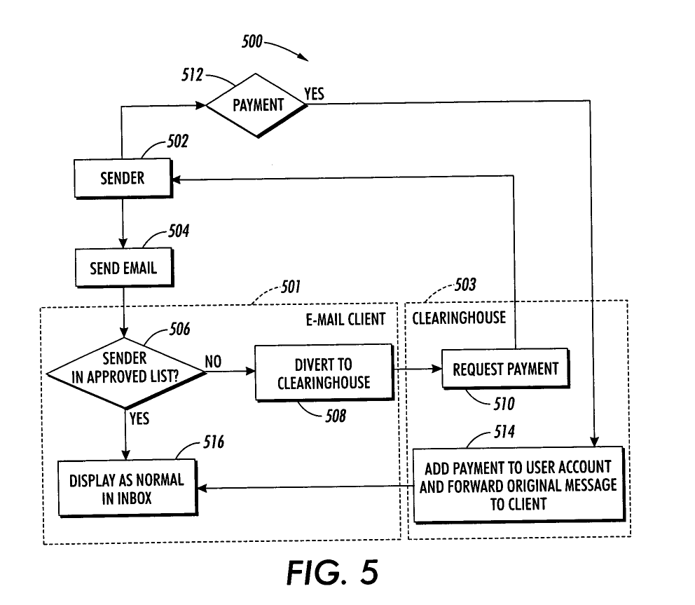

FIG. 5 illustrates a high-level flow chart 500 depicting logical operational steps that can be implemented in accordance with embodiments thereof. E-mail can be initially transmitted from a sender, as indicated at block 502 and sent as illustrated at block 504 to an e-mail client 501, which is indicated generally in FIG. 5 as an area surrounded by dashed lines. As depicted at block 506, the e-mail address associated with the sender can be compared against a pre-approved list of e-mail addresses from which e-mail messages are approved for transmission to an e-mail recipient. The e-mail recipient in question is the e-mail recipient that the sender is attempting to contact via e-mail. Thus, as depicted at block 506 the e-mail address of the sender can be automatically compared to the pre-approved e-mail list, which may be stored in a database, in response to transmission of the e-mail message from the sender to the e-mail client 501 (i.e., the e-mail recipient).

If, as indicated, at block 506, it is determined that the e-mail address of the sender is not identified within the database or list or pre-approved e-mail addresses, the e-mail sent by the sender can be diverted, as indicated at block 508 to a clearinghouse 503, which is also indicated generally in FIG. 5 by an area surrounded by dashed lines. The clearinghouse 503 can reply to the sender offering paid access, as indicated at block 519 and/or a free offer to access a request form. If the sender agrees to the offer, then an account of the sender is automatically debited as indicated at block 512 and payment thereafter made to the user (i.e., the e-mail recipient), as indicated at block 514.

The e-mail message can then be forwarded by the clearinghouse for normal display within the e-mail recipient's “inbox” as indicated at block 516. Note that if the sending e-mail address is originally identified in the list of pre-approved e-mail addresses as indicated at block 506, then the original e-mail address of the sender is automatically forwarded to the e-mail recipient for display in the recipient's “inbox” as depicted respectively at blocks 506 and 516. The clearinghouse 503 also automatically offers to approve the sender's e-mail address for transmission of the e-mail message and subsequent e-mail messages from the sender's e-mail address to the e-mail recipient in return for a payment thereof if the sender's e-mail address does not match a pre-approved e-mail address in the database or list of pre-approved e-mail addresses.

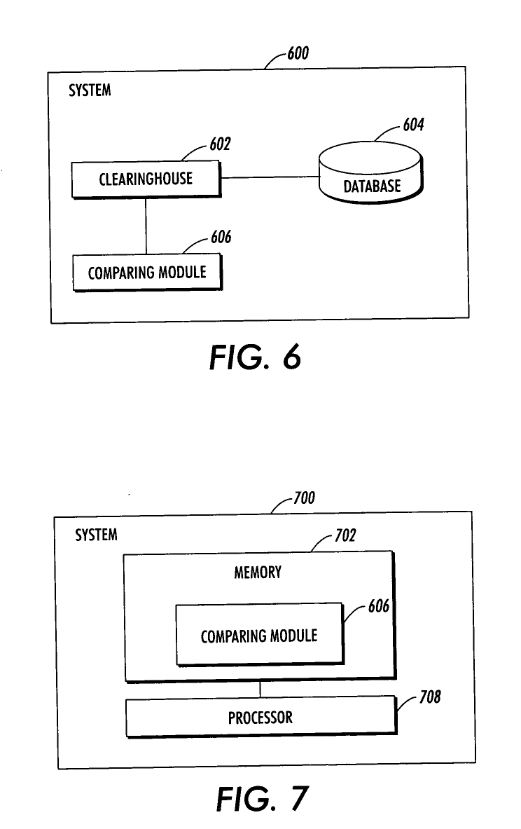

FIG. 6 illustrates a block diagram depicting a system 600 which can be implemented in accordance with an alternative embodiment of the present invention. In general, system 600 includes a database 604 of pre-approved e-mail addresses from which e-mail messages thereof are approved for transmission to an e-mail recipient. Additionally, system 600 includes a comparing module 606 for automatically comparing a particular e-mail address (e.g., a sender's e-mail address) to the database 604 of pre-approved e-mail addresses, wherein such a particular e-mail address is automatically compared to the database 604 in response to transmitting an e-mail message from the particular e-mail address to the e-mail recipient.

Note that embodiments can be implemented in the context of modules (e.g., comparing “module” 606). In the computer programming arts, a module can be typically implemented as a collection of routines and data structures that performs particular tasks or implements a particular abstract data type. Modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media. An example of a suitable module, which may be implemented in accordance with embodiments of the present invention, includes comparing module 606 of FIG. 6.

System 600 also includes a clearinghouse 602 associated with the database 604 and the comparing module 606, wherein the clearinghouse 602 automatically generates an offer to approve the particular e-mail address for transmission of the e-mail message and subsequent e-mail messages from the particular e-mail address to the e-mail recipient in return for a payment thereof if the particular e-mail address does not match a pre-approved e-mail address in the database of pre-approved e-mail addresses. Clearinghouse 602 of FIG. 6 is analogous to clearinghouse 503 depicted in FIG. 5. Clearinghouse 602 can also be implemented as a software module or collection of software modules.

Clearinghouse 602 can additionally automatically forward the e-mail message originally sent by the sender to e-mail recipient if this particular e-mail address matches a pre-approved e-mail address in the database 604 or list of pre-approved e-mail addresses. Clearinghouse 602 automatically debits an account associated with the user or sender, in response to an acceptance by the sender of user of the offer to approve the sending e-mail address for transmission of the e-mail message and/or subsequent e-mail messages from the sender's e-mail address to the e-mail recipient in return for the payment thereof. The clearinghouse 602 can also be configured to automatically provide a commission to a third-party in response to automatically debiting the account associated with the user of the particular e-mail address.

Clearinghouse 602 can also automatically offer to transmit a name of the user or sender of the particular e-mail address and a subject of the e-mail message to the e-mail recipient if the e-mail address of the user/sender does not match a pre-approved e-mail address in the database 604 of pre-approved e-mail addresses. Additionally, the clearinghouse 602 can automatically transmit the name of the sender or user of the sending e-mail address and the subject of the e-mail address originally sent to the e-mail recipient in response to an acceptance by the user/sender of the offering by the clearinghouse 602 to transmit the name of the user and the subject of the e-mail message to e-mail recipient.

Clearinghouse 602 can also automatically offer to refund the user or sender of the particular e-mail address if the e-mail recipient requests a sender's payment be refunded. Additionally, the clearinghouse 602 can automatically add the e-mail address of the particular sender to the database of approved senders if the e-mail recipient requests the particular sender's e-mail address added.

FIG. 7 illustrates a block diagram depicting a system 700 which can be implemented in accordance with an alternative embodiment of the present invention. System 700 includes comparing module 606, which is analogous, similar and/or identical to comparing module 606 of FIG. 7. System 700 includes a memory 702, which may be, for example, a memory of a computer or data-processing system such as a computer, laptop computer, server, personal digital assistant (PDA), and the like. Comparing module 606 may be retrieved and processed via a processor 708, such as a microprocessor or collection of processing units. An example of processor 708 is, for example, a central processing unit (CPU) or other microprocessor of a data-processing system such as a computer, laptop computer, server, personal digital assistant (PDA), cellular telephone, and the like.

Alternative embodiments of the present invention can be implemented using an internet mail service provider (ISP), such as Yahoo, MSN, AOL and the like. A server-based software module can be utilized to implement a clearinghouse, such as clearinghouse 606 and/or 503 illustrated herein. Such a server-based module can also be utilized to implement a comparing module, such as comparing module 606 of FIGS. 6 and 7. Such a server-based module can check all incoming e-mail messages to determine if the sender's e-mail address matches a list item or other predetermined criteria.

A personal address book maintained within a client e-mail management program such as Microsoft Outlook, for example, can be utilized as a basis for forming such a list or a database such as database 604 of FIG. 6. If the sender's address is acceptable, the message continues to the recipient's inbox as normal. If the sender's address is not acceptable, the ISP server retains the message. The ISP server replies to the sender that the recipient is offering a choice of paid access which may be optionally refunded by the recipient if the recipient chooses to do so or, if the sender thinks the recipient knows the sender, the sender may request free accessing providing the recipient only with the sender's name and subject of the original e-mail message.

If the sender chooses paid access (i.e., a transaction that can be handled by the ISP), the ISP server will release the original message to the recipient and the recipient's bank account (or another third party chosen by the recipient) will be credited, minus a commission paid to the ISP or another third-party. If the sender requests free access, the request will be sent by the recipient to the clearinghouse. If the recipient accepts the request, the acceptance is sent to the clearinghouse, which will release the original message to the recipient. The clearinghouse itself can be managed by the ISP and stored as one or more software modules on one or more servers owned or operated by the ISP.

Internet service providers are in a position to also solicit advertisers to pay for access to their user population based demographic information that the ISP may have obtained from their subscribers. In such a situation, the transaction would appear similar from the recipient's perspective to regular e-mail messaging, but the sender would obtain pre-approval prior to transmitting an e-mail message to the sender. Additionally, any clearinghouse implemented can generate additional revenue by offering the recipient the option to participate in an openly published e-mail directory (without the fear of becoming a “spam” target). Internet “links” can be added to such a directory to request free or paid access directly. The advantage of such a directory is that the recipients can be identified (i.e., similar to a telephone directory), but such recipients may only be contacted with permission and/or payment.

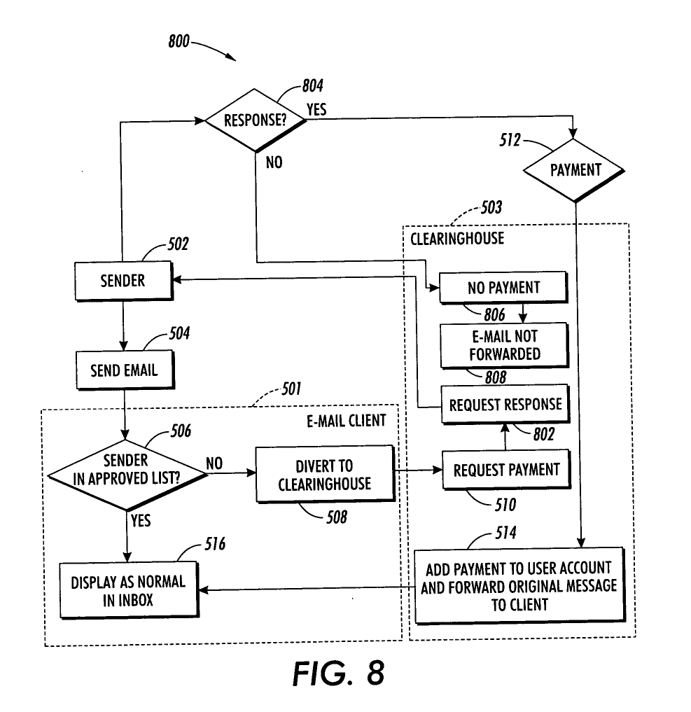

In any e-mail system involving the transfer of funds, steps should be taken to prevent identity theft and maintain security for both e-mail senders and recipients. Thus, FIGS. 8 to 10 illustrate varying high-level flow charts of operations of logical operational steps that can be implemented in accordance with alternative embodiments thereof. FIGS. 8 to 10 generally present several methods for verifying the identity of a transaction prior to automatically charging a paid account that has been previously established by an e-mail sender. Such methods can prevent unscrupulous senders from forging e-mail headers with the intent to impersonate another sender, and access the true sender's financial accounts. Additionally, an unscrupulous recipient may actually send themselves a forged e-mail message, thereby impersonating a paid sender and enriching their account. Note that in FIGS. 5, 8, 9 and 10, similar or identical parts are generally indicated by identical reference numerals.

FIG. 8 illustrates a high-level flow chart 800, which is similar to that of flow chart 500 of FIG. 5, but differs through the addition of blocks 802, 804, and 806. In FIG. 8, clearinghouse 503 generates a reply e-mail message to a pre-paid sender by return e-mail requesting that in addition to payment, as indicated at block 510, the sender also provide a response prior to charging their account and transmitting the sender's original e-mail message to the recipient. A request for such a response can be made, as indicated at block 802 to the sender. If the sender provides such a response, as indicated at block 804, payment is made as indicated at block 512 and thereafter, the payment is added to the user account and the original message forwarded to the e-mail client as indicated at block 514 and ultimately displayed within an “inbox” for the e-mail recipient, as indicated at block 516. If, however, as depicted at block 804, such a response is not provided by the sender, then as indicated thereafter at block 806, payment is not authorized. The e-mail message is not forwarded to the recipient as indicated at block 808.

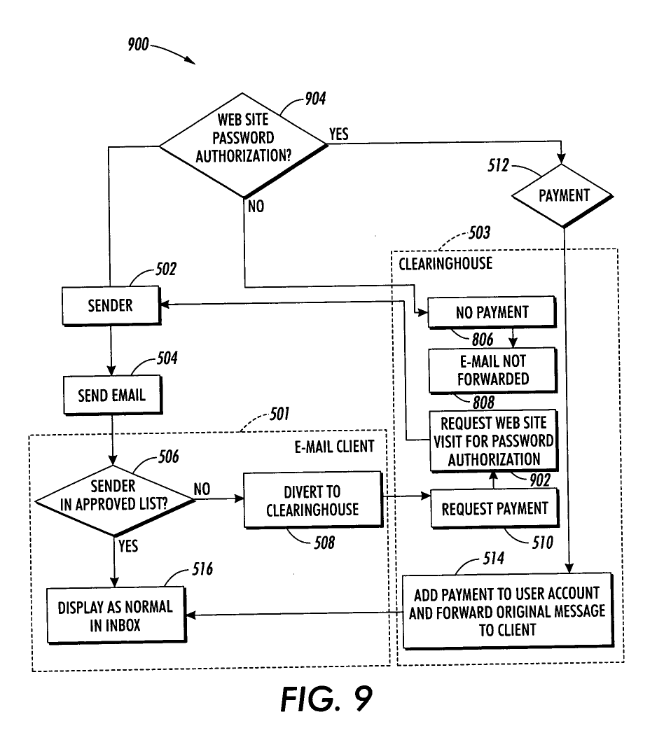

FIG. 9 illustrates a high-level flow chart 900, which is similar to that of flow chart 500 of FIG. 5, but differs through the addition of blocks 902, 904, 906, and 908. Flow chart 900 describes a method in which clearinghouse 503 generates a reply e-mail to the sender requesting that the sender visit a secure web site and enter a password authorizing the transfer of the funds prior to the actual transfer of the funds. Thus, in addition to a request for payment, which is described generally at block 510, a request is generated in the form of an e-mail message, as indicated at block 902, asking the sender to visit an authorized web site for password authorization.

If the sender visits the web site and enters the appropriate password, as indicated at block 904, then payment is made as indicated at block 512 and thereafter, the payment is added to the user account and the original message forwarded to the e-mail client as indicated at block 514 and ultimately displayed within an “inbox” for the e-mail recipient, as indicated at block 516. If, however, the user fails to visit the web site and/or enters an improper password, as indicated at block 904, payment is not made as indicated at block 906 and the e-mail is not forwarded as depicted at block 908.

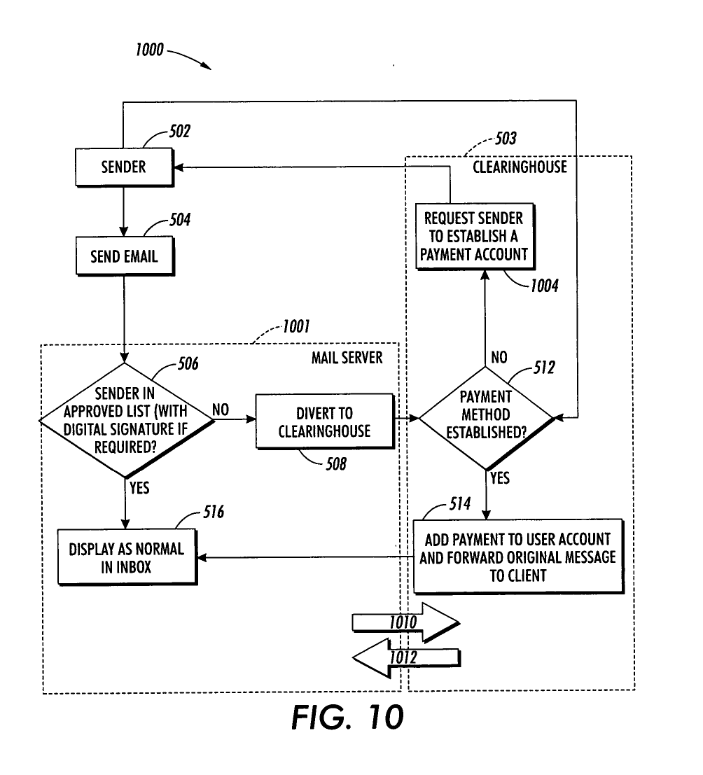

FIG. 10 illustrates a high-level flow chart 1000, which is similar to that of flow chart 500 of FIG. 5, but differs through the inclusion of block 1004. In FIG. 10, mail server 1001, can perform the operations indicated by blocks 508 and 516. FIG. 10 therefore depicts a method for providing additional security to the e-mail and financial transactions described herein by requiring the sender to utilize a digital signature in their e-mail messages to avoid issues related to the origin of the e-mail message. E-mail can be initially transmitted from a sender, as indicated at block 502 and sent as illustrated at block 504 to mail server 1001, which is indicated generally in FIG. 10 as an area surrounded by dashed lines.

As depicted at block 506, the e-mail address associated with the sender is compared against a pre-approved list of e-mail addresses from which e-mail messages are approved for transmission to an e-mail recipient. In this case, the e-mail recipient in question is the e-mail recipient that the sender is attempting to contact via e-mail. Thus, as depicted at block 506 the e-mail address of the sender can be automatically compared to the pre-approved e-mail list, which may be stored in a database, in response to transmission of the e-mail message from the sender to the mail server 1001. Additionally, as indicated at block 506, not only can it be determined if the sender's e-mail address is in the pre-approved list of e-mail address, but optionally, whether or not the sender has also transmitted a digital signature (if required).

If, as indicated, at block 506, it is determined that the e-mail address of the sender cannot be identified within the database or list or pre-approved e-mail addresses, the e-mail sent by the sender can be diverted, as indicated at block 508 to clearinghouse 503, which is also indicated generally in FIG. 10 by an area surrounded by dashed lines. Following processing of the operation depicted at block 508 in which a diversion to clearinghouse 503 is implemented, the operation indicated at block 1004 can be implemented in which the sender is requested to establish a payment account. This request can be transmitted back to the sender (i.e., see block 502) and thereafter, as indicated at block 512, a test can be performed to determine if a payment method has been established.

In the process of establishing an account, the sender can be encouraged to register a digital signature. Following processing of the operation depicted at block 512, the operation depicted at block 514 can be implemented wherein a payment is added to the user's (sender's) account and the original message forwarded to the e-mail recipient. The message can then be displayed, as indicated at block 516, in the “inbox” of the recipient. Arrows 1010 and 1012 indicates that a close integration exists between the mail server 1001 and the clearinghouse 502 of FIG. 10 to the point where clearinghouse 502 and mail server 1001 can act or function as a single server. The “approved list” for example can be maintained by clearinghouse 502 so that new senders can obtain immediate access to the recipient.

Note that in FIG. 10, more of the burden is placed on the service provider and/or internet service, rather on the recipient's computer. In FIGS. 5-9, the e-mail client 501 is indicated as the first line of spam-defense. In the model depicted in FIG. 10, however, the mail server 1001 acts as the first line of spam-defense. It can be appreciated that mail server 1001 can be modified, however, to contain all of the features of clearinghouse 503, depending upon a particular embodiment.

Variations to the above-referenced methods and configurations can be implemented to take into account the fact that a sender may actually be known to a recipient. For example, if the sender is a friend of the recipient, the sender can agree to pay to send an e-mail to the recipient with the expectation that the sender will be refunded at the recipient's discretion. The recipient can thus receive an e-mail message with the payment, but can “click” on a “link” (i.e., either in the e-mail message itself or on a website) to refund the sender's money and/or add the sender's e-mail address, name and other identifying information to the database (e.g., database 604) for free access thereafter. In the case of an altered e-mail address, the sender can already be provided with an account or recognition of their e-mail address at a website associated with the clearinghouse (e.g., clearinghouse 602).

The clearinghouse can offer a form to the sender to enter the old e-mail address and the new e-mail address. Such a change would not take effect until the old e-mail address replies to a message from the clearinghouse, or if the clearinghouse received a returned-undeliverable message. In this case, the sender's address would be updated for all recipients that have a relationship with the clearinghouse.

Additionally, the clearinghouse (e.g., clearinghouse 602) can retain the sender's e-mail message for a predetermined amount of time so that the recipient may review the list of blocked e-mail messages occasionally to assure the user (e.g., e-mail recipient) that the service is not blocking desired messages. Such a technique is useful to user's who may, for example, subscribe to an online newsletter, but do not know the e-mail address to add to the list until the first newsletter is received.

Embodiments described herein are thus generally directed toward a form of personal digital rights management to create disincentives to unsolicited or mass e-mail marketing, while retaining the openness of the current e-mail system. Such embodiments are compatible with the current e-mail infrastructure and offer a monetary incentive for end-users to adopt such systems. An e-mail recipient will not receive unsolicited e-mail unless the sender is willing the pay the recipient and/or a third party. The recipient may set the price, providing him or her with an incentive to utilize the service.

The clearinghouse can operate as an automated service, handling the transactions thereof for a fee. E-mail is then passed through normally if the sender is familiar with the client (e.g., in a corporate e-mail directory and/or personal address book). Client applications such as Microsoft Outlook, Eudora and/or Lotus notes, for example, can utilize a client version, which could be configured as a module that tests all incoming messages to determine if the sender's address matches a list item or other predetermined criteria. In general, two approaches for e-mail protection, security and filtering are disclosed herein. In the first approach, which is generally represented herein by FIGS. 5-9, the e-mail client (e.g., e-mail client 501) performs all filtering and forwards the rejected mail to the clearinghouse (e.g., clearinghouse 503). In the second approach, which is depicted FIG. 10, however, all filtering can be accomplished via the remote mail server and the rejected mail never actually reaches the client.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method, comprising:
compiling a database of pre-approved e-mail addresses from which e-mail messages thereof are approved for transmission to a particular e-mail recipient;
automatically comparing a particular e-mail address to said database of pre-approved e-mail addresses, in response to transmitting an e-mail message from a sender of said particular e-mail address to said particular e-mail recipient; and
automatically offering to approve said particular e-mail address for transmission of said e-mail message and subsequent e-mail messages from said particular e-mail address to said particular e-mail recipient in return for a payment thereof if said particular e-mail address of said sender does not match a pre-approved e-mail address in said database of pre-approved e-mail addresses.

2. The method of claim 1 further comprising automatically forwarding said e-mail message to a clearinghouse, which automatically offers to approve said particular e-mail address for transmission of said e-mail message and subsequent e-mail messages from said particular e-mail address to said particular e-mail recipient in return for said payment thereof if said particular e-mail address does not match a pre-approved e-mail address in said database of pre-approved e-mail addresses.

3. The method of claim 1 further comprising automatically forwarding said e-mail message to said particular e-mail recipient if said particular e-mail address of said sender matches a pre-approved e-mail address in said database of pre-approved e-mail addresses.

4. The method of claim 1 further comprising automatically debiting an account associated with said sender of said particular e-mail address, in response to an acceptance by said sender of an offer to approve said particular e-mail address for transmission of said e-mail message and subsequent e-mail messages from said particular e-mail address to said particular e-mail recipient in return for said payment thereof.

5. The method of claim 1 further comprising automatically offering to transmit a name of said sender of said particular e-mail address and a subject of said e-mail message to said particular e-mail recipient if said particular e-mail address does not match a pre-approved e-mail address in said database of pre-approved e-mail addresses.

6. The method of claim 5 further comprising transmitting said name of said sender of said particular e-mail address and said subject of said e-mail address to said particular e-mail recipient in response to an acceptance by said sender of said particular e-mail address of said offering to transmit said name of said sender and said subject of said e-mail message to said particular e-mail recipient.

7. The method of claim 1 further comprising offering said particular e-mail recipient an option to participate in an openly published e-mail directory in which said e-mail directory contains electronic links for requesting access to said particular e-mail recipient.

8. The method of claim 1 further comprising requiring said sender to verify an identity of said sender.

9. A method, comprising:
compiling a database of pre-approved e-mail addresses from which e-mail messages thereof are approved for transmission to a particular e-mail recipient;
automatically comparing a particular e-mail address to said database of pre-approved e-mail addresses, in response to transmitting an e-mail message from said particular e-mail address to said particular e-mail recipient;
automatically forwarding said e-mail message to a clearinghouse, which automatically offers to approve said particular e-mail address for transmission of said e-mail message and subsequent e-mail messages from a sender of said particular e-mail address to said particular e-mail recipient in return for said payment thereof if said particular e-mail address does not match a pre-approved e-mail address in said database of pre-approved e-mail addresses;
requiring said sender to verify an identity of said sender;
automatically forwarding said e-mail message to said particular e-mail recipient if said particular e-mail address matches a pre-approved e-mail address in said database of pre-approved e-mail addresses and if said identity of said sender is verified;
automatically debiting an account associated with said sender of said particular e-mail address, in response to an acceptance by said sender of an offer to approve said particular e-mail address for transmission of said e-mail message and subsequent e-mail messages from said particular e-mail address to said particular e-mail recipient in return for said payment thereof.

10. The method of claim 9 further comprising automatically offering to transmit a name of said sender of said particular e-mail address and a subject of said e-mail message to said particular e-mail recipient if said particular e-mail address does not match a pre-approved e-mail address in said database of pre-approved e-mail addresses.

11. The method of claim 10 further comprising transmitting said name of said sender of said particular e-mail address and said subject of said e-mail address to said particular e-mail recipient in response to an acceptance by said sender of said particular e-mail address of said offering to transmit said name of said sender and said subject of said e-mail message to said particular e-mail recipient.

12. The method of claim 10 further comprising offering said particular e-mail recipient an option to participate in an openly published e-mail directory in which said e-mail directory contains electronic links for requesting access to said particular e-mail recipient.

13. A system, comprising:
a database of pre-approved e-mail addresses from which e-mail messages thereof are approved for transmission to a particular e-mail recipient;
a comparing module for automatically comparing a particular e-mail address to said database of pre-approved e-mail addresses, wherein said particular e-mail address is automatically compared to said database in response to transmitting an e-mail message from said particular e-mail address to said particular e-mail recipient; and
a clearinghouse associated with said database and said comparing module, wherein said clearinghouse automatically generates an offer to approve said particular e-mail address for transmission of said e-mail message and subsequent e-mail messages from said particular e-mail address to said particular e-mail recipient in return for a payment thereof if said particular e-mail address does not match a pre-approved e-mail address in said database of pre-approved e-mail addresses.

14. The system of claim 13 wherein said clearinghouse automatically forwards said e-mail message to said particular e-mail recipient if said particular e-mail address matches a pre-approved e-mail address in said database of pre-approved e-mail addresses.

15. The system of claim 13 wherein said clearinghouse automatically debits an account associated with a sender of said particular e-mail address, in response to an acceptance by said sender of an offer to approve said particular e-mail address for transmission of said e-mail message and subsequent e-mail messages from said particular e-mail address to said particular e-mail recipient in return for said payment thereof.

16. The system of claim 15 wherein said clearinghouse automatically provides a commission to a third-party in response to automatically debiting said account associated with said sender of said particular e-mail address.

17. The system of claim 13 wherein said clearinghouse automatically offers to transmit a name of said sender of said particular e-mail address and a subject of said e-mail message to said particular e-mail recipient if said particular e-mail address does not match a pre-approved e-mail address in said database of pre-approved e-mail addresses.

18. The system of claim 16 wherein said clearinghouse automatically transmits said name of said sender of said particular e-mail address and said subject of said e-mail address to said particular e-mail recipient in response to an acceptance by said sender of said particular e-mail address of said offering to transmit said name of said sender and said subject of said e-mail message to said particular e-mail recipient.

19. The system of claim 13 wherein said clearinghouse generates an offer to said particular e-mail recipient to participate in an openly published e-mail directory in which said e-mail directory contains electronic links for requesting access to said particular e-mail recipient.

20. The system of claim 15 wherein said clearinghouse provides a payment to an account associated with said particular e-mail recipient, in response to automatically debiting said account associated with said sender of said particular e-mail address.
